(19) United States
(12) Patent Application Publication
(10) Pub. No.: US 2023/0175903 A1
(43) Pub. Date: Jun. 8, 2023

(54) TENSION ALARM APPARATUS AND METHOD

(71) Applicant: PAUL MUELLER COMPANY, Springfield, MO (US)

(72) Inventor: Sean Cross, Morrisville, MO (US)

(73) Assignee: PAUL MUELLER COMPANY, Springfield, MO (US)

(21) Appl. No.: 17/821,971

(22) Filed: Aug. 24, 2022

Related U.S. Application Data
(60) Provisional application No. 63/236,921, filed on Aug. 25, 2021.

(51) Int. Cl. G01L 5/04; G01L 5/10

(52) U.S. Cl. CPC G01L 5/047; G01L 5/10

(57) ABSTRACT

Provided are portable apparatuses and associated methods for detecting high tension in a cord or hose and triggering an alarm. In one embodiment, a portable tension alarm apparatus is provided that includes an alarm system, a first connection point that is to be affixed to a cord or hose, and a second connection point that is to be affixed to the cord or hose, with slack between the two connection points, and that is attached to a triggering component of the alarm system.

### CROSS-REFERENCE TO RELATED APPLICATION

This application claims priority from U.S. Provisional Application No. 63/236,921, filed on Aug. 25, 2021, which is incorporated by reference in its entirety.

### FIELD OF THE INVENTION

The present disclosure relates generally to alarm apparatuses and more specifically to apparatuses for creating tension alerts.

### BACKGROUND OF THE INVENTION

Objects such as cords and hoses are commonly used in many fields, such as for connecting to mobile equipment or portable devices. Over tensioning of a cord, hose, or other similar object may cause damage to the object, connections thereto, or related equipment, which may create a safety hazard. Users often need a means for detecting such over tensioning and creating an alert.

### BRIEF DESCRIPTION OF THE DRAWINGS

FIGS. 1 and 2 are a schematic diagram and perspective view, respectively, of an exemplary tension alarm apparatus.

FIG. 3 is a schematic diagram of an exemplary tension alarm apparatus.

FIG. 4 is a system diagram of an exemplary tension alarm apparatus in use.

FIG. 5 is a system diagram of an exemplary tension alarm apparatus in use.

### DETAILED DESCRIPTION

The following disclosure provides different embodiments, or examples, for implementing different features of the subject matter. Specific examples of components, features, arrangements, or steps are described below to simplify the present disclosure. These are, of course, merely examples and are not intended to be limiting.

In one embodiment, the invention can include an apparatus for measuring or detecting tension and for creating an alarm, such as by producing an alarm sound or transmitting an alert signal. The apparatus can alert a user to the over tensioning, or potential over tensioning, of a cord, hose, or similar object, such as over tensioning resulting from moving or stretching the cord or moving something to which the cord is connected. For example, the apparatus can alert a user before damage is caused to the cord or hose, a connection thereto, or other related equipment, such as equipment to which the cord or hose is directly or indirectly connected. In one example, the apparatus can warn of and prevent excessive strains placed on a cord or hose, or on connections thereto, before the cord, hose, or connection is broken or damaged in a way that its performance is impacted. In one example, the apparatus can warn when a break or tear occurs in a cord or hose, or a connection thereto. References herein to a cord or a hose encompass any such similar object.

In one embodiment, the tension alarm apparatus can comprise two or more connection points and an alarm system. In one example, the two or more connection points can include one or more triggering connection points. For example, a triggering connection point can trigger, operate, and/or be attached to the alarm system or one or more components thereof. In one example, the two or more connection points can also include one or more static connection points. In one embodiment, each of the two or more connection points can be affixed to a cord, or to an object or structure to which the cord is directly or indirectly connected, with slack in the cord between the two or more connection points, such that the apparatus can measure or detect tension applied to the cord and/or a break.

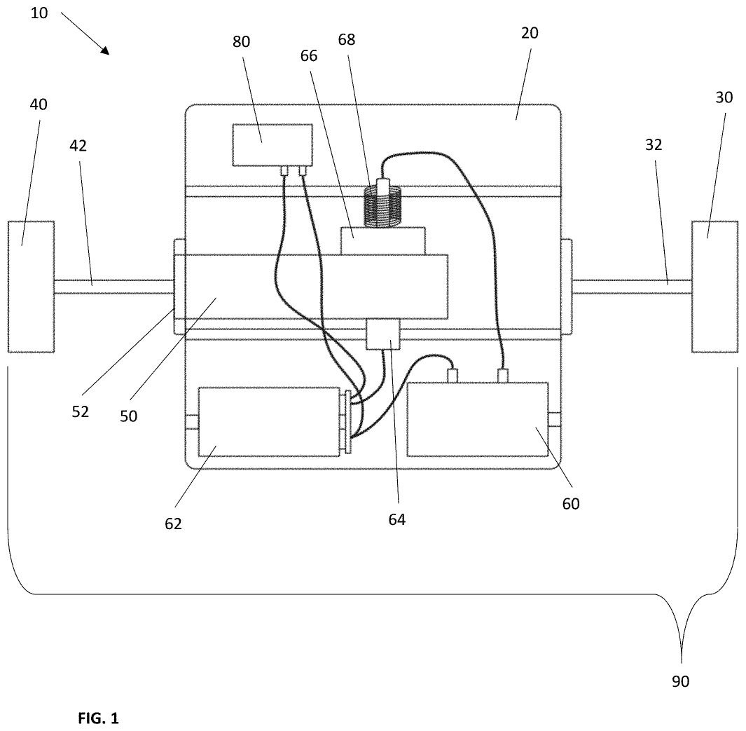

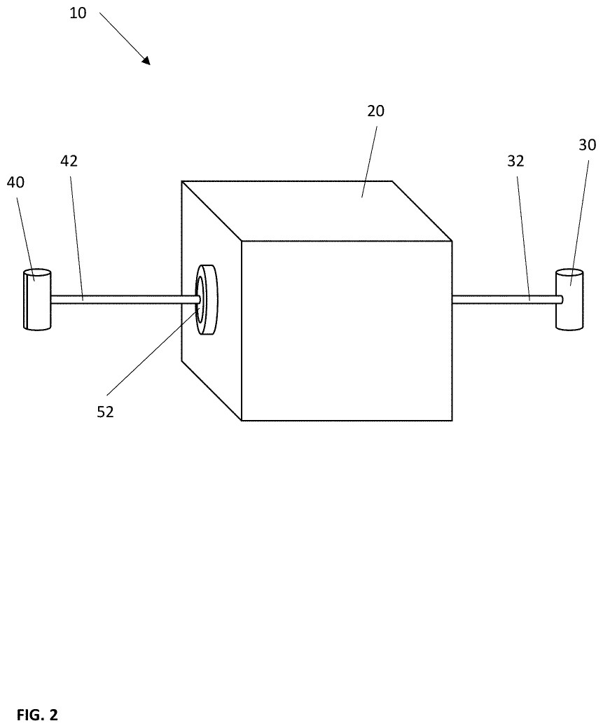

FIGS. 1 and 2 are a schematic diagram and perspective view, respectively, of an exemplary tension alarm apparatus 10. As shown in FIGS. 1 and 2, apparatus 10 includes a body 20, which can be a rigid plastic, hard rubber, or metal housing, or other rigid material. Apparatus 10 further includes a static connection point in the form of a first clamp 30, which is attached to body 20 via a first connection cable 32. Apparatus 10 further includes a triggering connection point in the form of a second clamp 40, which is attached via a second connection cable 42 to a current barrier 50 that is normally housed in the body 20. The current barrier 50 is normally retained in the body 20 by a release cap 52. The body 20 of apparatus 10 houses components of an alarm system, including alarm 60, battery 62, first circuit contact 64, second circuit contact 66, compressed spring 68 associated with second circuit contact 66, and low-battery alarm 80.

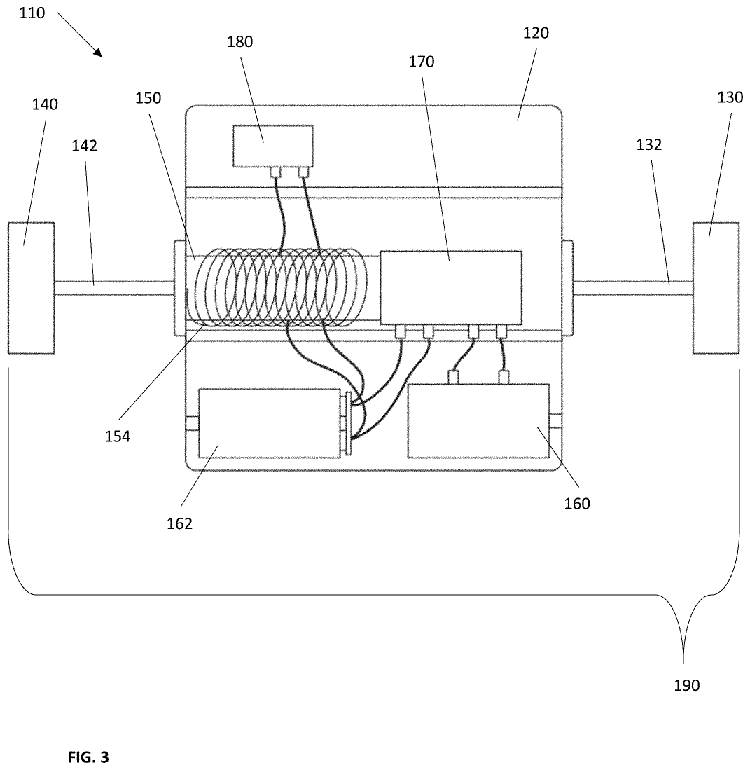

FIG. 3 is a schematic diagram of an exemplary tension alarm apparatus 110. As shown in FIG. 3, apparatus 110 includes a body 120, which can be a rigid plastic or metal housing. Apparatus 110 further includes a static connection point in the form of a first clamp 130, which is attached to body 120 via a first connection cable 132. Apparatus 110 further includes a triggering connection point in the form of a second clamp 140, which is attached via a second connection cable 142 to a circuit connector 150 associated with an uncompressed spring 154. The body 120 of apparatus 110 houses components of an alarm system, including alarm 160, battery 162, sensor 170, and low-battery alarm 180.

In one embodiment, the apparatus measures or detects tension in a cord (e.g., electrical cord), hose (e.g., a hose for high-pressure liquid or gas), cable, wire, rope, chain, leash, or other flexible object with at least two ends.

In one embodiment, the apparatus includes at least one triggering connection point that can be directly or indirectly affixed to a cord. In one embodiment, the apparatus can also include one or more corresponding connection points, such as a one or more static connection points and/or one or more additional triggering connection points. In one example, a corresponding static connection point or corresponding additional triggering connection point can be affixed to the cord or can be affixed to some point relative to the cord. For example, a point relative to the cord can be a stationary point on an object or structure to which the cord is directly or indirectly connected or can be a point at which the cord connects to such an object or structure.

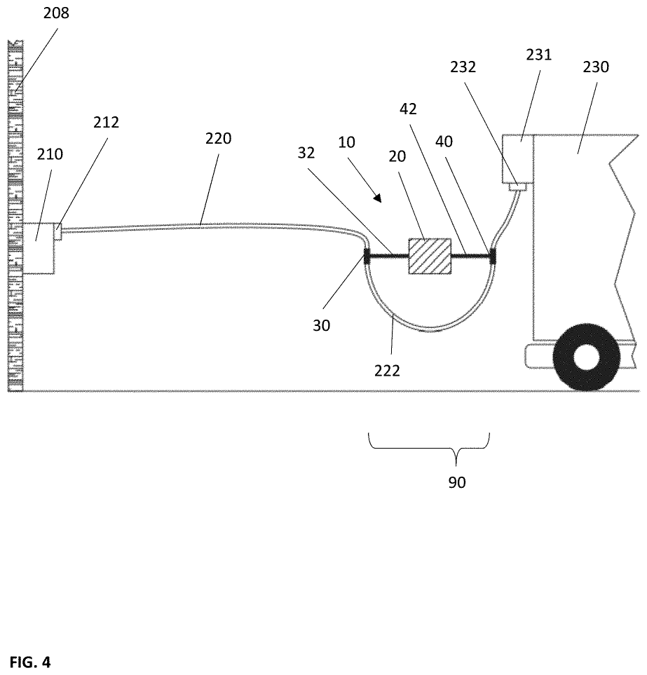

FIG. 4 is a system diagram of exemplary tension alarm apparatus 10 in use. As shown in FIG. 4, a power cord 220 is connected to a power station 210 on wall 208 via first cord end 212 and is also connected to a power supply 231 of mobile equipment 230 via second cord end 232. Mobile equipment 230 is mobile and can be moved, changing the tension applied to power cord 220. Apparatus 10 is affixed to power cord 220 at two connection points and can measure or detect tension in power cord 220 to alert a user before over tensioning of power cord 220, which can cause damage or harm to power cord 220, power station 210 or wall 208, the connection between power station 210 and first cord end 212, mobile equipment 230 or the power supply 231 thereof, or the connection between power supply 231 and second cord end 232. The two connection points with which apparatus 10 is affixed to power cord 220 include a static connection point in the form of first clamp 30, which is attached to the body 20 of apparatus 10 via first connection cable 32, and a triggering connection point in the form of a second clamp 40, which is attached to the body 20 (or current barrier 50 normally housed within body 20) via second connection cable 42. Alternatively, one of first clamp 30 and second clamp 40 could be affixed to wall 208, power station 210, the connection between power station 210 and first cord end 212, mobile equipment 230, power supply 231, or the connection between power supply 231 and second cord end 232. Alternatively, apparatus 10, or body 20 thereof, can be permanently or detachably affixed to or integrated into wall 208, power station 210, mobile equipment 230, or power supply 231, such that apparatus 10 can measure or detection tension or a break in power cord 220 using a single connection point (i.e., second clamp 40), and first clamp 30 and first connection cable 32 can be removed. For example, the apparatus can be affixed or integrated into a wall (or other structure) or object to which the cord is connected, and the apparatus can include only a single connection point that can be affixed to a cord to measure or detect tension or a break in the cord, or in a connection between the cord and the wall or object. In one example, an apparatus affixed or integrated into a wall or object to which the cord is connected can be powered by the object or through a power outlet in or near the wall, such as a common outlet used for powering the object to which the cord is connected. For example, apparatus 10 can be powered by an outlet in wall 208 or by power station 210, mobile equipment 230, or power supply 231.

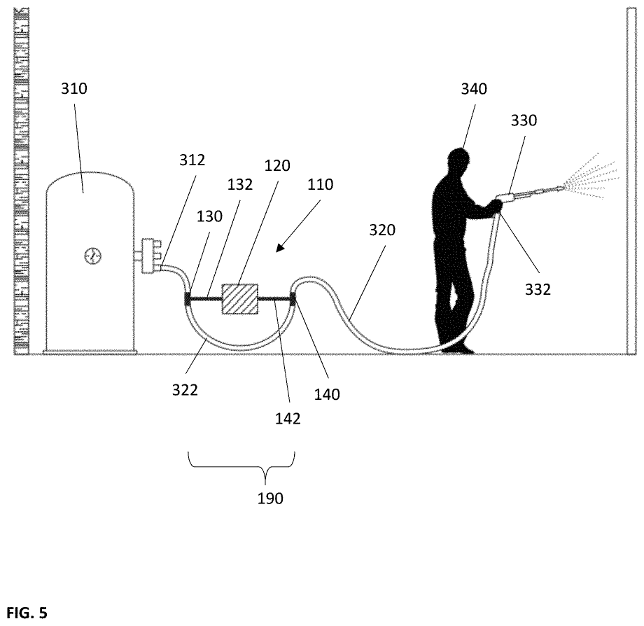

FIG. 5 is a system diagram of exemplary tension alarm apparatus 110 in use. As shown in FIG. 5, a high-pressure hose 320 is connected to a stationary tank 310 via first hose end 312 and is also connected to a portable equipment 330 via second hose end 332. Portable equipment 330 is portable and can be moved, changing the tension applied to hose 320. Apparatus 110 is affixed to hose 320 at two connection points and can measure or detect tension in hose 320 to alert user 340 before over tensioning of hose 320, which can cause damage or harm to hose 320, stationary tank 310, the connection between stationary tank 310 and first hose end 312, portable equipment 330, the connection between portable equipment 330 and second hose end 332, or user 340 of portable equipment 330. The two connection points with which apparatus 110 is affixed to hose 320 include a static connection point in the form of first clamp 130, which is attached to the body 120 of apparatus 110 via a first connection cable 132, and a triggering connection point in the form of a second clamp 140, which is attached to the body 120 (or circuit connector 150 normally housed within body 120) via a second connection cable 142. Alternatively, one of first clamp 130 and second clamp 140 could be affixed to stationary tank 310, the connection between station tank 310 and first hose end 312, portable equipment 330, the connection between portable equipment 330 and second hose end 332, or user 340 of portable equipment 330. Alternatively, apparatus 110, or body 120 thereof, can be permanently or detachably affixed to or integrated stationary tank 310, first clamp 130 and first connection cable 132 can be removed, and apparatus 110 can measure or detect tension or a break in hose 320 using a single triggering connection point (i.e., second clamp 140) affixed to hose 320.

In one embodiment, the apparatus can include more than one triggering connection point to measure or detect tension for a single cord. For example, multiple triggering connection points can detect and trigger alarms for different levels of tension on the cord. For example, a first triggering connection point for detecting a first lower threshold tension may break away or disengage from the apparatus or some part thereof (e.g., alarm system or body) at or near that first lower threshold tension, such that tension on the cord is then measured or subject to detection by a second triggering connection point for detecting a second higher threshold tension. In one example, the apparatus can include multiple triggering connection points each affixed to a single cord at different points. In one example, the apparatus can include multiple triggering connection points each affixed to a single cord at different points and can include at least one static connection point affixed to the cord or affixed to some point relative to the cord, such as an object or structure to which the cord is connected. In one example, the apparatus can include multiple triggering connection points each affixed to different points relative to a cord and/or of the cord and can include a static connection point affixed to the cord.

In one embodiment, the apparatus can include multiple triggering connection points for measuring or detecting tension for multiple cords. In one example, the apparatus can include multiple triggering connection points each affixed to a different cord. In one example, the apparatus can include multiple triggering connection points each affixed to a different cord and can include at least one static connection point affixed to some point relative to the multiple different cords. In one example, the apparatus can include multiple triggering connection points each affixed to a different cord and can include corresponding static connection points also affixed to the multiple different cords. In one example, the apparatus can include multiple triggering connection points each affixed to a point relative to a different cord, such as an object or structure to which the cord is connected, and can include corresponding static connection points affixed to the multiple different cords.

In one embodiment, there is slack in the cord between two or more affixed connection points, such that the apparatus may measure or detect tension applied to the cord or a break in the cord or a connection thereto. There can be slack in the cord when the two or more corresponding connection points of the apparatus are affixed to the cord and/or some point(s) relative to the cord. In one example, there can be slack in the cord when the cord and/or some object directly or indirectly connected to the cord is/are moved such that a maximum distance is reached between the two or more affixed connection points.

For example, as shown in FIG. 4, when first and second clamps 30, 40 are affixed to power cord 220, there is a slack portion 222 of power cord 220 between first and second clamps 30, 40, such that apparatus 10 can measure or detect tension applied to power cord 220 due to movement of mobile equipment 230. As shown in FIGS. 1 and 4, apparatus 10 includes a maximum distance 90 between first clamp 30 and second clamp 40, and as shown in FIG. 4, when apparatus 10 is affixed to power cord 220, the length of slack portion 222 is greater than maximum distance 90. Also, for example, as shown in FIG. 5, when first and second clamps 130, 140 are affixed to high-pressure hose 320, there is a slack portion 322 of hose 320 between first and second clamps 130, 140, such that apparatus 110 can measure or detect tension applied to hose 320 due to movement of portable equipment 330 by user 340. As shown in FIGS. 3 and 5, apparatus 110 includes a maximum distance 190 between first clamp 130 and second clamp 140, and as shown in FIG. 5, when apparatus 110 is affixed to hose 320, the length of slack portion 322 is greater than maximum distance 190.

In one example, there can be slack in a cord between a triggering connection point affixed to the cord and a corresponding static or additional triggering connection point affixed to the cord, as shown in FIGS. 4 and 5. In one example, there can be slack in a cord between a triggering connection point affixed to the cord and a corresponding static or additional triggering connection point affixed to some point relative to the cord, such as an object or structure to which the cord is connected. In one example, there can be slack in a cord between a triggering connection point affixed to some point relative to the cord and a corresponding static or additional triggering connection point affixed to the cord. In one embodiment, the amount of slack may be determined and set upon affixing the apparatus to a cord. For example, a user may select nearly any amount of slack. For example, the amount of slack can be between 1 and 3 feet, although the minimum amount may be smaller and the maximum amount may be larger.

In one embodiment, a triggering or static connection point of the apparatus can include a fastening device. A fastening device can affix, fasten, or secure the connection point of the apparatus to, for example, a cord or other related object or structure. For example, the fastening device of a connection point can be a clamp, such as first and second clamps 30, 40 of apparatus 10 and first and second clamps 130, 140 of apparatus 110. In one example, the fastening device can be affixed to, and unaffixed from, a cord or cord-like object without damaging (e.g., puncturing) the cord or object. In one example, the fastening device can be affixed to a cord or cord-like object of nearly any size diameter. For example, the diameter of the cord to which the fastening device may be affixed can be between 0.25 and 6 inches, such as from 0.5 to 1.5 inches, although the minimum size may be smaller and the maximum size may be larger.

In one embodiment, the apparatus is portable. For example, the apparatus can be unaffixed from a first cord and/or related objects or structures and can be affixed to a second different cord and/or related objects or structures. In one example, apparatus 10 shown in FIG. 4 may be unaffixed from power cord 220 by detaching first and second clamps 30, 40 from power cord 220, and apparatus 10 may then be transported and used to measure or detect tension in a different cord or hose, such as by affixing first and second clamps 30, 40 of apparatus 10 to high-pressure hose 320 shown in FIG. 5. In one embodiment, the apparatus, or the alarm system thereof, can be self-powered, such as by including one or more rechargeable or replaceable batteries, or can be powered by via an outlet.

In one embodiment, a triggering or static connection point of the apparatus can include a fastening device, such as a clamp, that is directly or indirectly attached to a part or body of the apparatus that houses or includes one or more components of an alarm system, such as body 20 of apparatus 10 or body 120 of apparatus 120. In one example, a connection point can be directly attached to, located on, integrated into, or part of the apparatus body, such as in a fixed position or a dynamic position (e.g., adjustable or rotatable position). In one example, a connection point can be attached to the apparatus body via a flexible attachment, such as a cable, or a rigid attachment, such as a metal rod. For example, first and second clamps 30, 40 are attached to body 20 of apparatus 10 via first and second connection cables 32 and 42, respectively, and first and second clamps 130, 140 are attached to body 120 of apparatus 110 via first and second connection cables 132 and 142, respectively. Connection cables 32, 42, 132, 142 can each be a cable, wire, or bar. For example, connection cables 32, 42, 132, 142 can be high-strength, flexible or rigid, metal, and/or rubber-coated.

In one example, a triggering connection point and an associated static or triggering connection point can both be located on or part of the apparatus body. In one example a triggering connection point can be directly located on or part of the apparatus body and an associated static or triggering connection point can be attached to the apparatus body (or component housed within the body) via an attachment such as a cable. In one example, a triggering connection point can be attached to the apparatus body (or component housed within the body) via an attachment such as a cable and an associated static or triggering connection point can be directly located on or part of the apparatus body. In one example, triggering connection point can be attached to the apparatus body (or component housed within the body) via an attachment such as a cable and an associated static or triggering connection point can also be attached to the apparatus body (or component housed within the body) via an attachment such as a cable, as first and second clamps 30, 40 are attached to body 20 (or current barrier 50 normally housed within body 20) via first and second connection cables 32, 42, respectively, and first and second clamps 130, 140 are attached to body 120 (or circuit connector 150 normally housed within body 120) via first and second connection cables 132, 142, respectively.

In one embodiment, the attachment (e.g., cable) between a connection point and some other part or component of the apparatus (e.g., the apparatus body or an alarm system component) can be a fixed length. For example, first connection cable 32 that connects first clamp 30 to body 20 is a fixed length and first connection cable 132 that connects first clamp 130 to body 120 is a fixed length, such that the fixed length of first connection cables 32, 132 sets a maximum distance that first clamps 30, 130 can extend away from bodies 20, 120, respectively. Also, for example, second connection cable 42 that connects second clamp 40 to current barrier 50 is a fixed length, such that the fixed length of second connection cable 42 sets a maximum distance that second clamp 40 can extend away from current barrier 50 and sets a maximum distance that second clamp 40 can extend away from body 20 while current barrier 50 is retained in its normal position within body 20 by release cap 52. Also, for example, second connection cable 142 that connects second clamp 140 to circuit connector 150 is a fixed length, such that the fixed length of second connection cable 142 sets a maximum distance that second clamp 140 can extend away from circuit connector 150 and sets a maximum distance that second clamp 140 can extend away from body 120 while circuit connector 150 is retained in its normal position within body 120 by uncompressed spring 154.

In one embodiment, the attachment, such as first and second connection cables 32, 42 and first and connection cables 132, 142, can be nearly any length. For example, the length of the attachment between a connection point and the apparatus body or alarm system component can be between 0.5 and 3 feet, although the minimum size may be smaller and the maximum size may be larger.

In one embodiment, the attachment (e.g., cable) between a connection point and some other part or component of the apparatus (e.g., the apparatus body or an alarm system component) can be a variable length, such that the distance (e.g., maximum distance) between the connection point and the other part of the apparatus can vary. In one example, this attachment length can vary based on an adjustment (e.g., manual adjustment or tension setting by a user) and/or a tension being measured or detected by the apparatus. In one example, the attachment (e.g., cable) can travel.

In one embodiment, the apparatus includes one or more alarm systems for measuring or detecting tension in a cord, hose, or other similar object to which it is affixed. In one example, the alarm system can measure tension applied to a cord and/or can detect whether a threshold or triggering amount of tension is reached or exceeded by the tension on a cord. In one example, the apparatus can detect whether multiple different triggering amounts of tension are reached or exceeded. For example, the apparatus can detect multiple different triggering amounts of tension using a single alarm system or multiple alarm systems and using a single triggering connection point or multiple triggering connection points. For example, the apparatus can detect whether a first lower triggering amount of tension is reached and can then detect whether a second higher triggering amount of tension is reached.

In one embodiment, the triggering tension, and the tension strength of the subject cord and the apparatus and components thereof, can be increased exponentially. For example, the triggering tension can be nearly any amount of tension. In one embodiment, a triggering tension is adjustable. For example, the apparatus can allow for detecting variable triggering tensions and a user may adjust one or more triggering tension levels for the apparatus. For example, a triggering tension may be manually or automatically adjusted based on one or more characteristics of the cord or hose being monitored by the apparatus.

In one embodiment, a triggering connection point can be associated with an alarm system. For example, a triggering connection point can be directly or indirectly attached to, and/or can operate, one or more components of an alarm system. For example, a triggering tension on a cord can cause the triggering connection point or a related component (e.g., an alarm system component directly or indirectly attached to the triggering connection point) to move or otherwise be actuated such that the alarm system is triggered. In one example, a single triggering connection point or multiple triggering connection points can be associated with a single alarm system. In one example, a single triggering connection point can be associated with multiple alarm systems. In one example, a single triggering connection point can detect one or more triggering tensions.

In one embodiment, one or more alarm systems can be partially or wholly housed in a body of the apparatus. For example, multiple alarm systems may be housed in a single body or multiple alarm systems can be housed in multiple corresponding bodies of the apparatus. In one embodiment, an apparatus body housing an alarm system may comprise one or more openings (e.g., holes). For example, an opening in the body may allow one or more components—such as a component of the alarm system, a component of or related to the triggering connection point, and/or a component that directly or indirectly connects the triggering connection point to a component of the alarm system—to enter or be inserted into the body or alarm system, to exit or be removed from the body or alarm system, or both.

For example, body 20 of apparatus 10 shown in FIGS. 1 and 2 includes an opening through which current barrier 50 can be inserted into or removed from the body 20 and the alarm system housed therein. Current barrier 50 can be inserted into the body 20 through the opening to arm the alarm system of apparatus 10, and current barrier 50 is then retained in its normal position within body 20 by release cap 52 until, for example, a triggering tension level is reached that causes release cap 52 to fail and current barrier 50 to be removed from (e.g., pulled out of) body 20 and the alarm system therein. In one example, release cap 52 can be substituted for some other variable tension release component or system for retaining current barrier 50 until a triggering tension is applied, such as a spring.

For example, body 120 of apparatus 110 shown in FIG. 3 includes an opening through which circuit connector 150 can be partially removed from body 120 and sensor 170 of the alarm system housed therein. Circuit connector 150 is retained in its normal position within body 120 by uncompressed spring 154 until, for example, a triggering tension level is reached that causes uncompressed spring 154 to become compressed and circuit barrier 150 to be removed from (e.g., pulled out of) body 120 and sensor 170 therein. Uncompressed spring 154 allows circuit connector 150 to be partially or wholly removed from (e.g., pulled out of) body 120 and sensor 170 of the alarm system therein when a triggering tension level is reached but retracts circuit connector 150 back into its normal position within body 120 when the triggering tension is relieved. In one embodiment, the apparatus can use a combination of the release cap 52 of apparatus 10 and the uncompressed spring 154 of apparatus 110. For example, the apparatus can detect a first triggering tension upon breaking of a release cap and a second triggering tension upon moving an alarm system component against a spring. Alternatively, for example, the apparatus can detect a first triggering tension upon moving an alarm system component against a spring and a second triggering tension upon breaking of a release cap.

In one embodiment, the alarm system can include nearly any type of alarm or sensor. For example, the alarm system can include any type of alarm or sensor capable of measuring or detecting a triggering tension level. For example, the alarm system can use proximity sensing, positioning, current sensing, optical sensing, and/or magnetic sensing. For example, the alarm system can use a normally open system or a normally closed system.

As shown in FIG. 1, apparatus 10 includes an alarm system that includes an alarm 60, battery 62, first circuit contact 64, second circuit contact 66, compressed spring 68 associated with second circuit contact 66, and low-battery alarm 80. The alarm system of apparatus 10 includes a normally open circuit—involving alarm 60, battery 62, and first and second circuit contacts 64, 66—and current barrier 50 as a circuit interrupter with variable tension release. In one example, current barrier 50 can be rigid plastic. When current barrier 50 is inserted into its normal position within body 20, current barrier 50 separates first circuit contact 64 and second circuit contact 66 to interrupt the circuit, and the alarm system of apparatus 10 is thus deactivated and armed to detect a triggering tension. When a triggering tension level is reached in a cord being monitored by apparatus 10 (e.g., power cord 220 shown in FIG. 4), the triggering tension causes a force to pull current barrier 50, via second clamp 40 and second connection cable 42, against release cap 52 such that release cap 52 will fail (e.g., will break away, be pulled out, or otherwise be released or removed) and current barrier 50 will be pulled out of its normal position within body 20 and out from between first and second circuit contacts 64, 66. Compressed spring 68 will then force second circuit contact 66 toward first circuit contact 64 until first and second circuit contacts 64, 66 touch and close the circuit between alarm 60 and battery 62, thus triggering alarm 60. In one example, first and second circuit contacts 64, 66 can be metal circuit connections.

In one embodiment, alarm 60 can include an audio alarm component, such as a piezo disc alarm or other noise creator capable of producing one or more high-frequency and/or loud alarm sounds. In one embodiment, alarm 60 can include a visual alarm component, such as one or more LED strobe lights.

In one embodiment, the apparatus can transmit a wired signal or wireless signal, such as an alarm notification signal. For example, the apparatus may include a wired communication component or a wireless communication component to transmit the signal. In one example, the wireless component can send the wireless signal via radio frequency (RF), RFID technology, wireless LAN (e.g., Wi-Fi), wireless PAN (e.g., Bluetooth), cellular communication (e.g., LTE, GSM, or CDMA), and/or the Internet. The signal may be sent to notify, for example, a system or person located remote to the apparatus that the alarm is triggered. In one example, the signal can alert one or more persons via a text message or email when a triggering tension is detected.

In one embodiment, the wired or wireless communication component can be included in the apparatus body, such as body 20 of apparatus 10. For example, the communication component can be included in or connected to alarm 60. Alternatively, the communication component can replace alarm 60 in apparatus 10. For example, apparatus 10 can include a wireless communication component within body 20 and connected to the alarm system circuit, alarm 60 (e.g., including a visual alarm component and/or audio alarm component) can be outside of and physically separate from apparatus 10, and upon the detection of a triggering tension by apparatus 10, the wireless communication component can directly or indirectly transmit a signal to alarm 60 that triggers alarm 60.

In one embodiment, the apparatus can perform a shutoff related to the cord, hose, or other similar object in response to a triggering tension. For example, upon detecting a triggering tension in a cord or hose, the apparatus can, in addition to triggering an alarm, shut off a device, system, power source, or equipment (e.g., a machine) to which the cord or hose is connected, such as by shutting off a power source providing power through the cord or shutting off a source of gas or fluid flowing through the hose. In one example, the apparatus can be remotely or directly connected to the main circuit of the related device, system, power source, or equipment, such that the apparatus can control power thereto and shut off that power upon detection of a triggering tension. In one example, the apparatus can accommodate for various voltages.

In one embodiment, the apparatus can produce multiple alarm responses (e.g., sound, visual indication, signal transmission, and/or shut-off event) for a single triggering tension. In one embodiment, the apparatus can produce different alarm responses for different triggering tensions, or a multi-stage alarm response, such as a first alarm response (e.g., sound, light, and transmission of a notification signal) in response to a first lower triggering tension (e.g., a potential over-tensioning) and a second alarm response (e.g., shut-off event) in response to a second higher triggering tension (e.g., an over-tensioning or break).

The power source for the alarm system of apparatus 10 is battery 62, which provides current for the circuit and power to alarm 60. In one example, battery 62 can be a replaceable or rechargeable battery. In one example, apparatus 10 may also include a back-up battery. Apparatus 10 also includes a low-battery alarm 80, which is wired to battery 62 and can monitor the status of battery 62, sense when battery 62 has a low or depleted charge, and produce an alarm, such as a sound, a visual indication, or a wireless transmittal of a low-battery notification.

As shown in FIG. 3, apparatus 110 includes an alarm system that includes alarm 160, battery 162, sensor 170, and low-battery alarm 180. The alarm system of apparatus 110 includes a normally closed circuit involving alarm 160, battery 162, sensor 170, and circuit connector 150. For example, circuit connector 150 includes a metal conductor. When circuit connector 150 is retained in its normal position within body 120 and sensor 170 therein, circuit connector 150 closes or completes the circuit between alarm 160 and battery 162 via an electrical connection in sensor 170, and the alarm system of apparatus 110 is thus deactivated and armed to detect a triggering tension. When a triggering tension level is reached in a cord being monitored by apparatus 110 (e.g., high-pressure hose 320 in FIG. 5), the triggering tension causes a force to pull circuit connector 150, via second clamp 140 and second connection cable 142, against normally uncompressed spring 154 and out of sensor 170, which breaks or opens the normally closed circuit and thus triggers alarm 160. For example, when circuit connector 150 is retained in its normal position in sensor 170, it can touch multiple contacts necessary to close the alarm system circuit, but when circuit connector 150 is pulled out of sensor 170 by a triggering tension, at least one such contact does not touch circuit connector 150 and the circuit is thus opened.

The power source for the alarm system of apparatus 110 is battery 162, which provides current for the circuit and power to alarm 160. Apparatus 110 also includes a low-battery alarm 180, which is wired to battery 162 and can monitor the status of battery 162, sense when battery 162 has a low or depleted charge, and produce an alarm, such as a sound, a visual indication, or a wireless transmittal of a low-battery notification.

In one embodiment, the apparatus can be deactivated by retraction or re-insertion of a component that is moved or removed by a pulling force caused by a triggering tension. For example, alarm 60 of apparatus 10 can be deactivated by re-insertion of current barrier 50 into body 20 to separate first and second circuit contacts 64, 66. For example, alarm 160 of apparatus 110 can be deactivated by retraction of circuit connector 150 into sensor 170 to relieve uncompressed spring 154 and close the circuit between alarm 160 and battery 162.

In one embodiment, the apparatus alarm system can include an optical sensor and circuit. For example, the electrical circuit systems in apparatus 10 and apparatus 110 can instead be optical circuit systems. In one example, apparatus 10 can comprise an optical sensor and a normally open optical circuit that is interrupted by barrier 50, and a triggering tension can cause the removal of barrier 50, the closing of the optical circuit, and thus the triggering of alarm 60.

In one embodiment, the apparatus alarm system can include a magnetic reed switch or Hall Effect switch to open or close an electrical circuit and trigger an alarm when a triggering tension is detected. For example, the sensor 170 of apparatus 110 can use a Hall Effect sensor and circuit connector 150 can include a magnet.

In one embodiment, a connection point of the apparatus can allow for a cord to move through it, such as by sliding or on a roller or wheel. For example, instead of a triggering connection point being fastened to a cord such that the apparatus measures or detects tension applied to the cord, the apparatus can measure or detect the length of cord that travels through the triggering connection point, and the apparatus alarm can be triggered based on a certain distance of travel rather than a triggering level of tension. In one example, the connection point can allow a cord or cord-like object of nearly any size diameter to move through it, such as between 0.25 and 6 inches, although the minimum size may be smaller and the maximum size may be larger. For example, the connection point can include a variable sized opening that can adjust to accommodate cords of different sizes. In one example, the apparatus includes a distance capturing component, such as a wheel that can capture the movement of a cord through the connection point, from which a length of cord or distance of travel can be determined.

In one example, the apparatus may monitor a pet leash and can emit a high-frequency sound when a triggering tension is applied to the leash or when a certain length of the leash has passed through the apparatus, such as to alert a pet to relieve tension on a collar connected to the leash.

In one example, the apparatus may be used with a user's safety harness, related ropes, or other PPE during elevated work, such that a sound and visual indication are produced when a triggering tension is applied to a rope or rope-harness connection or when the harness nears the end of the maximum length of the rope.

The invention also comprises a method for detecting tension in a cord or hose and triggering an associated alarm. The method can comprise providing an apparatus as described herein for measuring or detecting tension applied to a cord. The method can further comprise affixing at least connection point of the apparatus to the cord and affixing at least one corresponding connection point of the apparatus to a different point of the cord or to some related object or structure, such as a wall, equipment, or device to which the cord is connected, such that there is slack in the cord between the at least two affixed connection points. For example, if the at least two affixed connection points are both affixed to the cord, then the length of the cord between those two points of the cord is longer than the maximum distance of the apparatus from the first affixed connection point to the second affixed connection point. Affixing a connection point can include clamping a clamp of the apparatus, for example, to the cord.

The method can further comprise monitoring the tension applied to the cord and detecting a triggering tension. For example, detecting a triggering tension can include retaining a circuit barrier or circuit connector within a normal position in the apparatus at tension levels below the triggering tension and moving the circuit barrier or circuit connector upon application of the triggering tension to the cord to which at least one of the connection points is affixed. For example, the connection point affixed to the cord can be directly or indirectly attached to the circuit barrier or circuit connector, such that a pulling force applied to that connection point by the triggering tension on the cord causes movement of the circuit barrier or circuit connector relative to a sensor or circuit contact of the apparatus alarm system. Such movement can result in a normally open circuit being closed or a normally closed circuit being opened, which can trigger an alarm.

In one embodiment, triggering an alarm can comprise alerting a user, for example, by producing a sound, producing a visual indication such as a flashing light, and/or transmitting a signal, such as a wireless alert notification. In one embodiment, the method can further comprise shutting off power or equipment related to the cord.

The method can further and/or alternatively include steps to implement or utilize variations of the tension alarm apparatus as described herein.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated.

1. A tension alarm apparatus comprising:
a body;
an alarm system housed in the body;
a first connection point, wherein the first connection point is operably attached to the alarm system and is configured to affix to a first position on a flexible object with at least two ends; and
a second connection point, wherein the second connection point is attached to the body and is configured to affix to a second position on the flexible object or relative to the flexible object,
wherein the apparatus is configured such that the alarm system is triggered via the first connection point by a triggering tension in the flexible object.

2. The tension alarm apparatus of claim 1, wherein the flexible object is a cord or a hose.

3. The tension alarm apparatus of claim 1, wherein the first and second connection points are configured to affix to the first and second positions such that the flexible object comprises a slack portion between the first connection point and second connection point.

4. The tension alarm apparatus of claim 3, wherein the length of the slack portion is greater than a maximum distance between the first connection point and the second connection point.

5. The tension alarm apparatus of claim 1, wherein the first connection point comprises a detachable fastening device.

6. The tension alarm apparatus of claim 1, wherein the first connection point is attached to a triggering component of the alarm system such that the triggering tension causes the first connection point to actuate the triggering component to trigger the alarm system.

7. The tension alarm apparatus of claim 6, wherein the triggering component is a circuit barrier or a circuit connector.

8. The tension alarm apparatus of claim 7, wherein the triggering component is a circuit barrier and the apparatus further comprises a release component configured to retain the circuit barrier in a normal position when the triggering tension is not applied to the flexible object and release the circuit barrier from the normal position when the triggering tension is applied to the flexible object.

9. The tension alarm apparatus of claim 1, wherein the apparatus is configured to perform a shutoff related to the flexible object when the alarm system is triggered.

10. The tension alarm apparatus of claim 1, wherein the alarm system comprises an alarm configured to alert a user when the alarm system is triggered.

11. The tension alarm apparatus of claim 1, wherein the first connection point is operably attached to the alarm system by a first flexible attachment and the second connection point is attached to the body by a second flexible attachment.

12. The tension alarm apparatus of claim 1, wherein the apparatus is configured such that the triggering tension that triggers the alarm system is adjustable.

13. A tension alarm apparatus comprising:
a body;
an alarm system housed in the body, wherein the alarm system comprises a triggering component and an alarm;
a first fastening device attached to the triggering component and configured to affix to a first position on a flexible object with at least two ends; and
a second fastening device attached to the body and configured to affix to a second position on the flexible object or relative to the flexible object,
wherein the apparatus is configured such that a triggering tension in the flexible object causes the triggering component to move via the first fastening device to trigger the alarm.

14. The tension alarm apparatus of claim 13, wherein the flexible object is a cord or a hose.

15. The tension alarm apparatus of claim 13, wherein the alarm system comprises a normally open circuit, the triggering component is a circuit interrupter, and the triggering tension causes the circuit interrupter to move via the first fastening device such that the normally open circuit closes to trigger the alarm.

16. The tension alarm apparatus of claim 15, wherein the alarm system comprises a release cap configured to retain the circuit interrupter in a normal position that interrupts the normally open circuit when the triggering tension is not applied and configured to fail to retain the circuit interrupter in the normal position when the triggering tension is applied.

17. The tension alarm apparatus of claim 13, wherein the alarm system comprises a normally closed circuit, the triggering component is a circuit connector, and the triggering tension causes the circuit connector to move via the first fastening device such that the normally closed circuit opens to trigger the alarm.

18. The tension alarm apparatus of claim 17, wherein the alarm system comprises a spring configured to retain the circuit connector in a normal position that closes the normally closed circuit when the triggering tension is not applied and configured to compress such that the circuit connector is removed from the normal position when the triggering tension is applied.

19. A method of detecting tension comprising:
providing a tension alarm apparatus comprising:
a body;
an alarm system housed in the body;
a first connection point operably attached to the alarm system; and
a second connection point attached to the body;
affixing the first connection point to a first position on a flexible object with at least two ends;
affixing the second connection point to a second position on the flexible object or a second object to which the flexible object is connected, wherein the flexible object comprises a slack portion between the first and second positions when the first and second connection points are affixed;
detecting a triggering tension in the flexible object; and
triggering the alarm system via the first connection point.

20. The method of claim 19, wherein detecting a triggering tension comprises pulling a circuit barrier or a circuit interrupter out of a normal position in the alarm system via the first connection point when the triggering tension is applied to the flexible object.
